(19) United States
(12) Patent Application Publication
(10) Pub. No.: US 2026/0299601 A1
(43) Pub. Date: Oct. 1, 2026

(54) CONTROLLING VEHICLES

(71) Applicant: AutoStore Technology AS, Nedre Vats (NO)

(72) Inventors: Øystein Myrmo, Jar (NO); Vegard Syre-Aaker, Asker (NO); Erik Strømme, Borgen (NO)

(21) Appl. No.: 19/478,984

(22) PCT Filed: Jan. 22, 2024
(86) PCT No.: PCT/EP2024/051348

§ 371 Date: Oct. 27, 2025

(30) Foreign Application Priority Data
Apr. 28, 2023 (NO) 20230485

(51) Int. Cl. G05D 1/644; B65G 1/137; G05D 1/69; G05D 105/20; G05D 107/70; G05D 109/10

(52) U.S. Cl. CPC G05D 1/644; B65G 1/1373; G05D 1/69; G05D 2105/20; G05D 2107/70; G05D 2109/14

(57) ABSTRACT

The disclosure relates to a method of controlling a plurality of container handling vehicles operating in an automated storage and retrieval system comprising defining a plurality of grid locations of the automated storage and retrieval system; defining a first subset of the plurality of grid locations as a virtual highway; determining a first job to be performed by a first container handling vehicle, the first job comprising a first position and a second position; determining a first path between the first position and the second position, wherein determining the first path comprises calculating a first cost for travelling from the first position to a first adjacent position on a first vector, based on the relative locations of the first vector and the virtual highway, calculating a second cost for travelling from the first position to a second adjacent position on a second vector, based on the relative locations of the second vector and the virtual highway, determining that the first vector is preferred over the second vector based at least in part on the first cost for travelling and the second cost for travelling, and adding the first vector to the first path.

### TECHNICAL FIELD

The disclosure relates to controlling vehicles. More particularly, it relates to a method of controlling a plurality of storage and retrieval vehicles operating in an automated storage and retrieval system.

### BACKGROUND

Traditional storage solutions usually involve the arrangement of goods on rows of shelves within a warehouse. The shelf location for each item is recorded in an inventory, and goods are retrieved from the shelves by a stock picker. The shelves are restocked and the inventory updated, as needed, as goods enter and leave the warehouse.

Warehouse workers may be assisted by robotic pickers and by automated inventory management systems. Automated transit systems may also be implemented in traditional warehouse set-ups to move goods from their inventory location to a picking and/or packing station.

An alternative to a traditional warehouse set-up is an automated storage and retrieval system in which robots retrieve items from their logged location within the warehouse and deliver the items to a packing station or port. Such systems can reduce or eliminate the space needed to pass between rows of shelves to access stock, thereby removing the need for broad aisles within the warehouse. One example of such a system involves placing goods in bins or containers that are configured to be stacked, side by side, within a three-dimensional grid. A rail system is arranged on top of the grid, along which robotic container-handling vehicles configured to lift containers from the grid can travel. The container-handling vehicles are configured to transport containers from the grid and to deliver them to ports or stations at the periphery of the grid so that the goods within the container can be picked and packed.

The robotic container-handling vehicles are capable of travelling at high speeds in X and Y directions along the rails, and a control system is provided to optimise route planning. When there are many vehicles operating on the rails, the various paths that the vehicles take may overlap or interact, causing congestion and ultimately slowing down the system due to vehicles waiting.

One known method of planning the routes of vehicles involves finding individual routes which bring each vehicle closer to their destination. For each vehicle, a route may be found which, in isolation, may be one of the best routes to take. However, with multiple vehicles operating at once, routes may overlap. This is particularly the case when some vehicles are travelling the whole span of the grid, increasing the chance of routes intersecting with other vehicles.

One or more aspects of the invention of the present application are set out in the claims.

### BRIEF DESCRIPTION OF THE DRAWINGS

The disclosure will now be described in more detail in connection with a number of exemplary embodiments shown in the accompanying drawings, in which:

FIG. 1 shows a perspective view of a storage system comprising a grid and a plurality of robotic container-handling vehicles configured to retrieve and/or rearrange goods stored within the grid;

FIG. 2 shows a top view of the system of FIG. 1;

FIG. 3A shows a side view of a first robotic container-handling vehicle suitable for use in the system of FIG. 1;

FIG. 3B shows a side view of a second robotic container-handling vehicle suitable for use in the system of FIG. 1;

FIG. 3C is a perspective side view of the robot of FIG. 3B;

FIG. 4 shows a computing device for implementing the operations described herein;

FIG. 5a shows a top down view of a grid for determining vehicle paths;

FIG. 5b shows a top down view of a grid for determining vehicle paths;

FIG. 5c shows a top down view of a grid for determining vehicle paths;

FIG. 5d shows a top down view of a grid for determining vehicle paths;

FIG. 5e shows a top down view of a grid for determining vehicle paths;

FIG. 5f shows a top down view of a grid for determining vehicle paths;

FIG. 5g shows a top down view of a grid for determining vehicle paths;

FIG. 5h shows a top down view of a grid for determining vehicle paths;

FIG. 6 shows steps according to method of determining vehicle paths;

FIG. 7a shows steps according to method of determining vehicle paths;

FIG. 7b shows steps according to method of determining vehicle paths;

FIG. 8 shows steps according to method of determining vehicle paths.

### DETAILED DESCRIPTION

In overview, the disclosure relates to controlling the movement of container handling vehicles by providing virtual highways through which vehicles may travel in a storage grid. When carrying out path finding for a job, a cost function may incentivise using the highway when it is appropriate to do so and disincentivize interacting with the highway in other ways (for example, crossing over the highway). Since the cost function affects how desirable a path is for a vehicle to take, traffic may be routed along the highway for long journeys and local traffic which does not require the highway may avoid obstructing the flow of vehicles on the highway. In this way, traffic which spans a large portion of the grid may benefit from high speed travel without interference from other traffic carrying out local activities throughout the grid. By avoiding these interactions which may lead to congestion, the vehicles may avoid wasted time due to starting and stopping movement, or by waiting for other vehicles to pass. Additionally, since the starting and stopping of high speed vehicles is reduced, energy consumption by those vehicles may also be reduced, allowing more jobs to be completed without requiring recharging or refuelling.

### Automated Storage and Retrieval System Overview

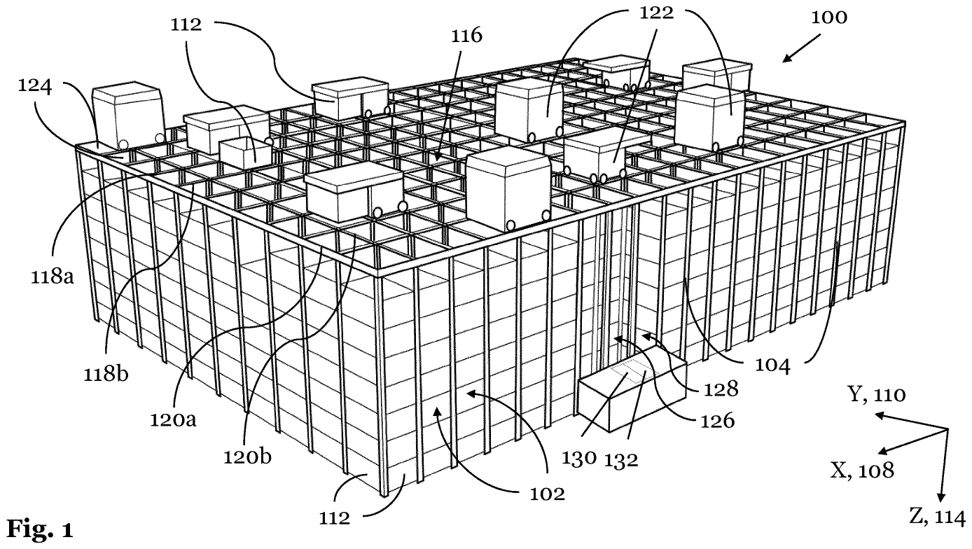

Referring to the embodiment shown in FIG. 1, a grid 100 comprises a frame formed by a plurality of generally rectilinear, adjacent vertical columns 102 formed between vertical frame members 104 and extending in the X and Y directions 108, 110. The grid elements may be fabricated of any appropriate material; for example, the frame members may be formed of extruded aluminium. Storage containers or bins 112 are stacked on top of each other, preferably in a self-supporting manner, in the Z direction 114 in the columns 102, forming a storage volume of storage cells for respective bins 112 extending in the X, Y and Z directions 108, 110, 114.

A rail system or network 116 is formed on top of the grid 100 and comprises pairs of vehicle rails or tracks 118a, 118b and 120a, 120b, respectively extending in the X and Y directions 108, 110. Robotic container-handling vehicles, or robots, 122, which can be of a range of size, shape and function, are provided and configured to run on the rails 118, 120 and to transport bins 112 in both the X and Y directions 108, 110. The robots 122 are additionally configured to lift and lower bins 112 from/into the columns 102 in the Z direction 114, the bins 112 optionally being guided by the vertical frame members 104. The robots 122 access the bins 112 via access openings 124 above the columns 102 and formed between the rails 118, 120.

Some columns 102 may be used for alternative purposes than bin storage. For example, port columns 126, 128 comprise port or access columns allowing transfer of a bin 112 in and/or out of the grid 100. Port columns 126, 128 provide a vertical channel for lifting of a bin 112 from, or lowering of a bin 112 to, a port or ports 130, 132. The ports 130, 132 are shown in FIG. 1 at the lowest level of the grid, however ports can be located at any vertical position along the column. The respective port columns 126, 128 can be assigned for removing (′drop-off) and/or returning or delivering (‘pick-up’) bins 112 from/to the grid 100. The ports 130, 132 are therefore configured to allow bins 112 to be removed and reintroduced (horizontally) into the associated port column. As such, a port 130, 132 can comprise a conveyor (not shown in FIG. 1) onto which a bin 112 may be lowered and transported horizontally out of the port column. The port columns 126, 128 include an opening or access point through which bins 112 can enter and leave the column.

Bins 112 can be transported along the top of the grid 100 to and/or from a port column 126, 128 by robots 122, and from a port 130, 132 to a location outside the grid 100, which may be an access station (not shown) for processing of the bin 112 or its contents, such as a picking station for adding content to, or removing content from, the bin 112. In alternative examples (not shown), the bin 112 may be transported to a port of another grid on the same or another level, or to an external facility. Transport of bins 112 to and from ports 130, 132 may be by any appropriate means (not shown) including conveyors, transport vehicles, lifts or robots.

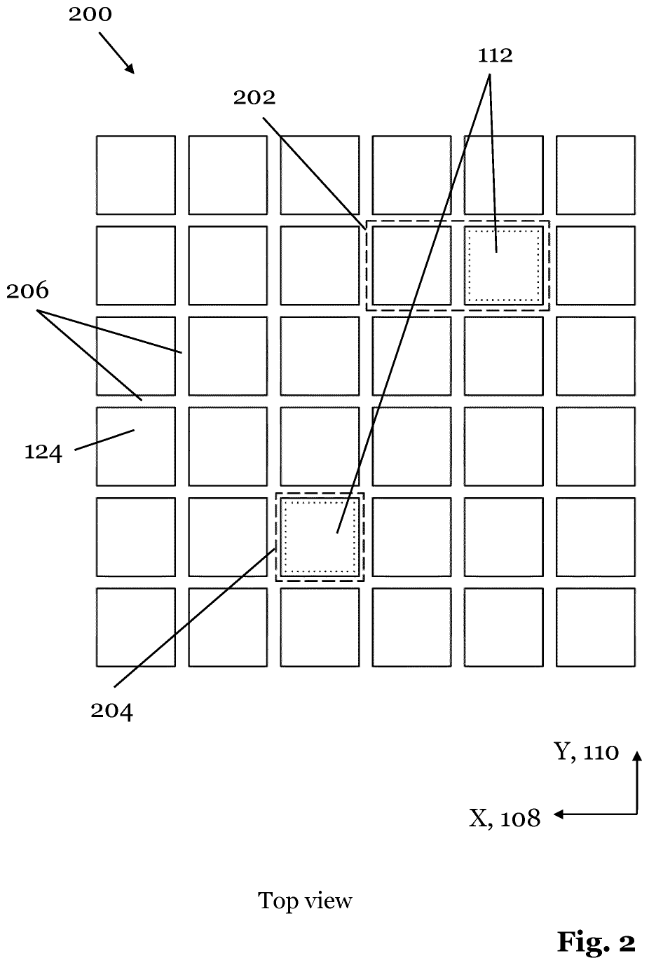

Referring to the embodiment shown in FIG. 2, the X-Y configuration 200 of the rail system 116 can be seen in more detail, together with robots 202, 204 of different types. The rail system includes rails 206 defining between them vertical column access openings 124 for access to bins 112. The rails 206 can be any appropriate type for permitting travel of the robots 202, 204 in the X and Y directions 108, 110 thereon, including (not shown) groove-type rails for receiving vehicle wheels, or protrusion-type rails for engaging wheel recesses. Each rail 206 may comprise a single track or multiple parallel tracks in each of the X and Y directions 108, 110.

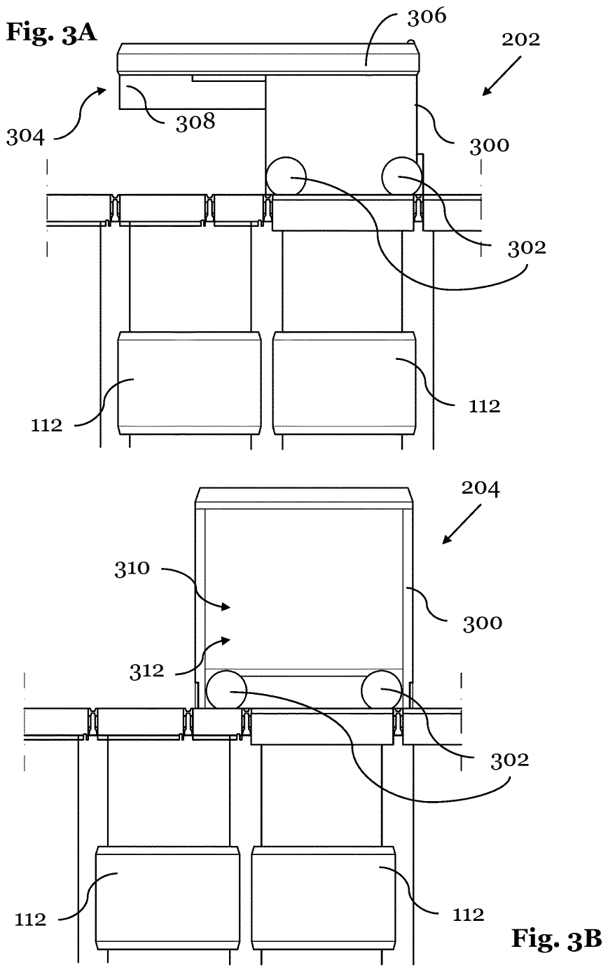

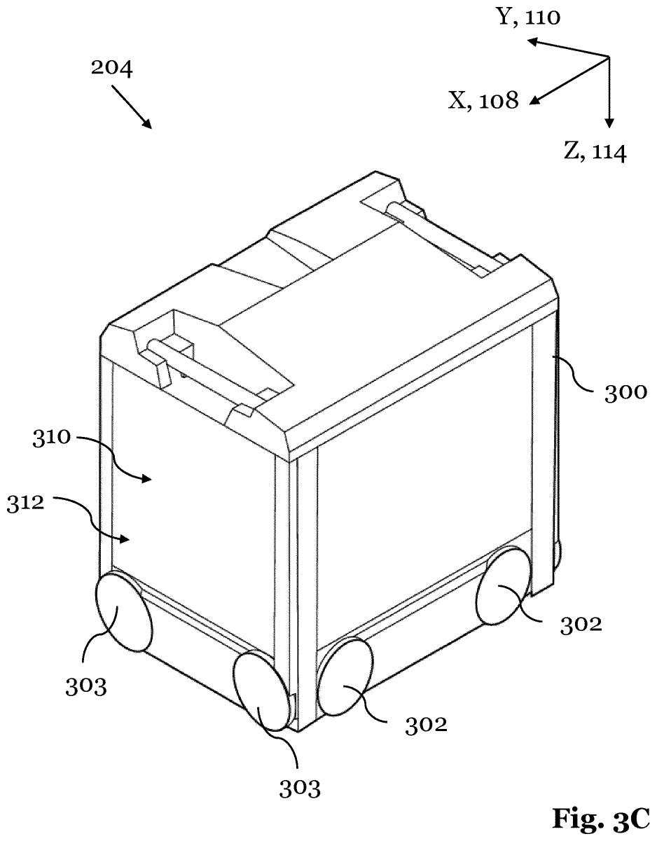

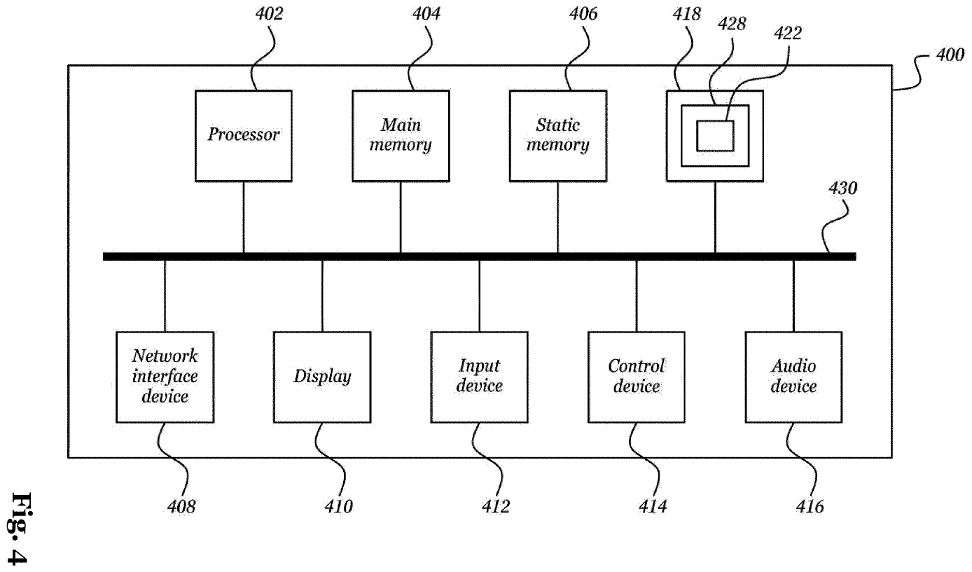

A first, ‘cantilever’ type of robot 202 is shown in more detail in FIG. 3A and includes a body 300, a set of wheels 302 and a lifting device 304. The body 300 contains operational equipment (not shown) for the robot 202 including drive, power and control systems. The wheels 302 permit movement of the robot 202 in one of the X and Y directions, an additional set of wheels (not visible in this view) permitting movement in the other of the X and Y directions, in both cases along the respective rails or tracks 206. One or both sets of wheels can be raised or lowered to permit selective engagement of the rails for movement in the desired direction. The lifting device 304 includes a cantilever element 306 extending in the X-Y plane from the top of the body 300, and a gripping device 308, which is raisable and lowerable from the cantilever element 306. The gripping device 308 is configured to grip or engage a bin 112; for example, by gripping a part of the bin 112, or by passively or actively engaging a suitably configured part of the bin 112.

A second, ‘internal cavity’ type of robot 204 is shown in more detail in FIG. 3B and includes, as an alternative to the cantilevered lifting system, an internal cavity 310 within the body 300 and in which the lifting device 312 including a gripping device (not shown) is located. In this case, the body 300 includes the robot's operational equipment and a storage space for one or more bins 112, for use, for example, while transporting the bin 112.

FIG. 3C shows a perspective side view of the robot of FIG. 3B in which the first set of wheels 302 from FIG. 3B are visible. The additional set of wheels referenced above but not shown in FIG. 3B are shown as wheels 303 in FIG. 3C. The additional set of wheels 303 is arranged perpendicular to the first set of wheels 302, to allow rolling of the robot 204 in the X and Y directions on the first and second set of wheels 302, 303 respectively. The first and second set of wheels 302, 303 shown in FIG. 3C may be configured to be independently lowered into engagement with the rails (and conversely raised out of engagement with the rails) to allow the robot 202 to move in the X and Y direction across the arrangement of rails shown in FIG. 2. Although the perspective view shown in FIG. 3C is of the robot 204 of FIG. 3B, it will be appreciated that a similar perpendicular wheel arrangement may be applied to the robot 202 of FIG. 3A.

### Control and Monitoring System

Control and monitoring of the automated storage and retrieval system, including monitoring and storing bin position and controlling bin delivery, retrieval and transport and robot routing and collision avoidance, is performed by a control system shown in FIG. 4 in communication with the robots and/or other controllable system components. Control can be performed locally or remotely and may be implemented by a processing system, for example in the form of a computing device. Accordingly, the methods described herein may form all or part of a computer-implemented method, or a system configured to perform the methods described herein.

With reference to FIG. 4, a processing system 400 suitable for carrying out the methods described herein will now be described. FIG. 4 shows a block diagram of one implementation of a processing system 400 in the form of a computing device within which a set of instructions for causing the computing device to perform any one or more of the methods described herein may be executed. In some implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term ‘computing device’ shall also be taken to include any collection of machines (e.g., computers) that individually or jointly execute a set (or multiple sets) of instructions to perform any one or more of the methods described herein.

The example processing system 400 includes a processor 402, a main memory 404 (e.g., read-only memory (ROM), flash memory, dynamic random-access memory (DRAM) such as synchronous DRAM (SDRAM) or Rambus DRAM (RDRAM), etc.), a static memory 406 (e.g., flash memory, static random-access memory (SRAM), etc.), and a secondary memory (e.g., a data storage device 418), which communicate with each other via a bus 430.

Processor 402 represents one or more general-purpose processors such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 402 may also be one or more special-purpose processors such as an application specific integrated circuit (ASIC), a field programmable gate array (FPGA), a digital signal processor (DSP), network processor, or the like. Processor 402 is configured to execute the processing logic (instructions 422) for performing the operations and steps described herein.

The processing system 400 may further include a network interface device 408. The processing system 400 also may include any of a video display unit 410 (e.g., a liquid crystal display (LCD) or a cathode ray tube (CRT)), an alphanumeric input device 412 (e.g., a keyboard or touchscreen), a cursor control device 414 (e.g., a mouse or touchscreen), and an audio device 416 (e.g., a speaker).

It will be apparent that some features of the processing system 400 shown in FIG. 4 may be absent. For example, the processing system 400 may have no need for display device 410 (or any associated adapters). This may be the case, for example, for particular server-side computer apparatuses which are used only for their processing capabilities and do not need to display information to users. Similarly, user input device 412 may not be required. In its simplest form, processing system 400 comprises processor 402 and main memory 404.

The data storage device 418 may include one or more machine-readable storage media (or more specifically one or more non-transitory computer-readable storage media) 428 on which is stored one or more sets of instructions 422 embodying any one or more of the methods or functions described herein. The instructions 422 may also reside, completely or at least partially, within the main memory 404 and/or within the processor 402 during execution thereof by the processing system 400, the main memory 404 and the processor 402 also constituting computer-readable storage media 428.

The various methods described herein may be implemented by a computer program. The computer program may include computer code arranged to instruct a computer to perform the functions of one or more of the various methods described herein. The computer program and/or the code for performing such methods may be provided to an apparatus, such as a computer, on one or more computer-readable media or, more generally, a computer program product. The computer-readable media may be transitory or non-transitory. The one or more computer-readable media could be, for example, an electronic, magnetic, optical, electromagnetic, infrared, or semiconductor system, or a propagation medium for data transmission, for example for downloading the code over the Internet. Alternatively, the one or more computer-readable media could take the form of one or more physical computer-readable media such as semiconductor or solid-state memory, magnetic tape, a removable computer diskette, a random-access memory (RAM), a read-only memory (ROM), a rigid magnetic disc, or an optical disk, such as a CD-ROM, CD-R/W or DVD.

The computer program is executable by the processor 402 to perform functions of the systems and methods described herein.

In an implementation, the modules, components, and other features described herein can be implemented as discrete components or integrated in the functionality of hardware components such as ASICS, FPGAs, DSPs, or similar devices.

A ‘hardware component’ is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase ‘hardware component’ should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

### Operation of the Automated Storage and Retrieval System

In operation, each bin 112 is given a unique identifier, which may be marked on the bin 112 using a computer-readable identifier (e.g., a barcode, quick-response code or radio-frequency identification tag) to ease identification of the bin 112. A database of the processing system 400 stores, in association with the unique identifier, the position and, optionally, content of each bin 112. When a bin 112 is moved (e.g., when it is retrieved from the grid 100), the database is updated to record its change in position.

When it is desired to retrieve a bin 112 from the grid 100, under control of the processing system 400, a robot 202, 204 is routed via the rail system 116 to the vertical column 102 including the storage cell where, according to the database, the bin 112 is positioned, and the lifting device 304, 312 is positioned (according to robot type) over the corresponding access opening 124, either adjacent or below the robot 202, 204. The robot 202, 204 lowers the gripping device 308 which engages, grips and lifts the bin 112 to the robot 202, 204. The robot 202, 204 then transports the bin 112, for example, to the drop-off port column 126, 128 for delivery to the port 130, 132 and subsequent processing external to the grid 100. In the event that the target or designated bin 112 is below other bins in the stack then the robot 202, 204 or multiple robots, which may be dedicated to the task, are controlled in a ‘digging’ operation to sequentially lift and reposition, temporarily or permanently, bins above the target bin 112 in order for it to be retrieved. It will be appreciated that other operations in relation to the bin 112 can be carried out in a similar manner. For example, a bin 112 can be delivered for storage in the grid 100 at the port 130, 132 of the pick-up port column 126, 128, gripped and lifted by a robot 202, 204 and delivered to the desired storage cell, bins above the desired position being repositioned if necessary as discussed above.

### Description of Specific Improvements

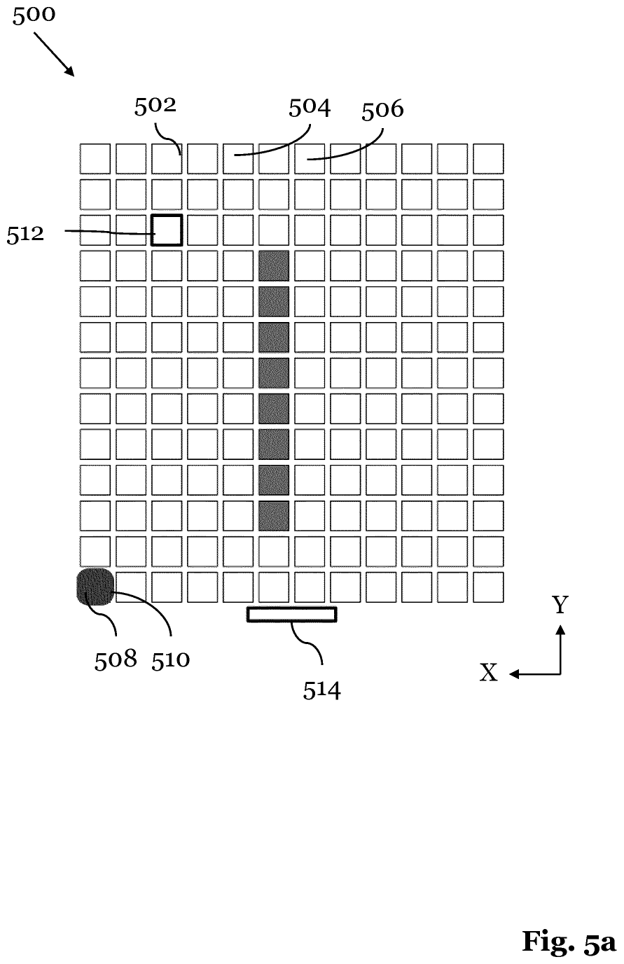

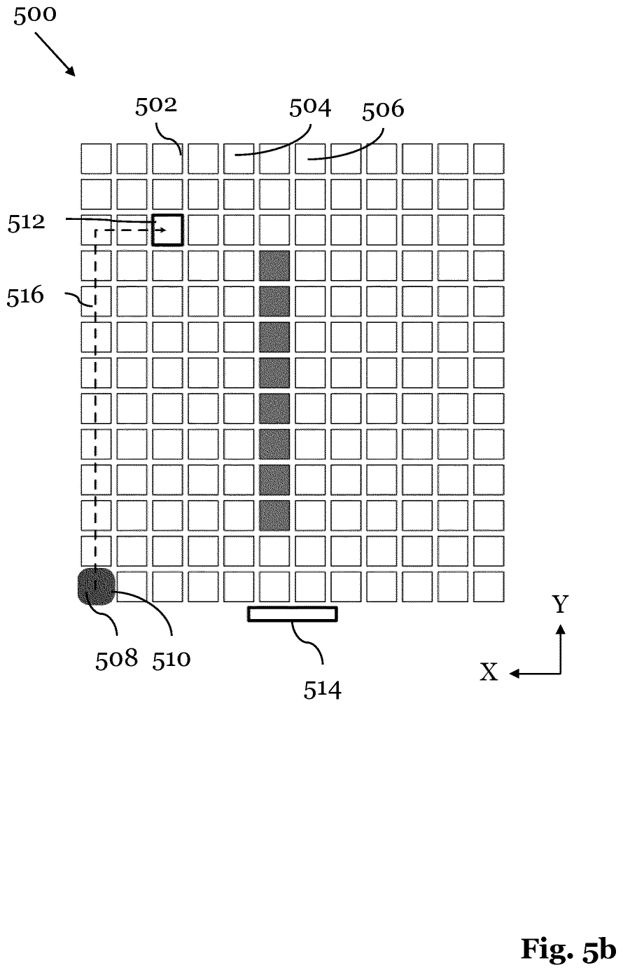

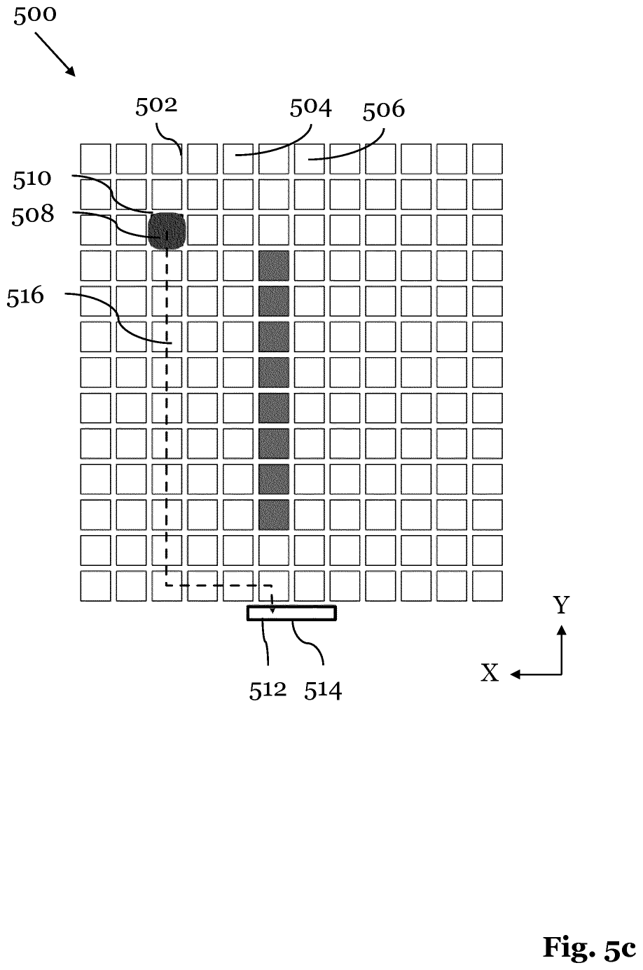

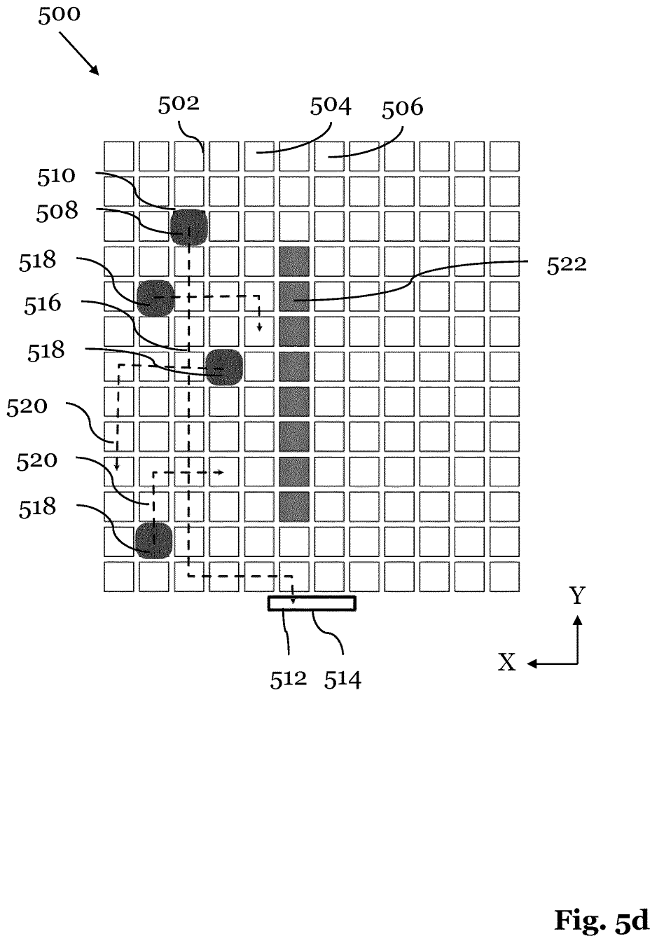

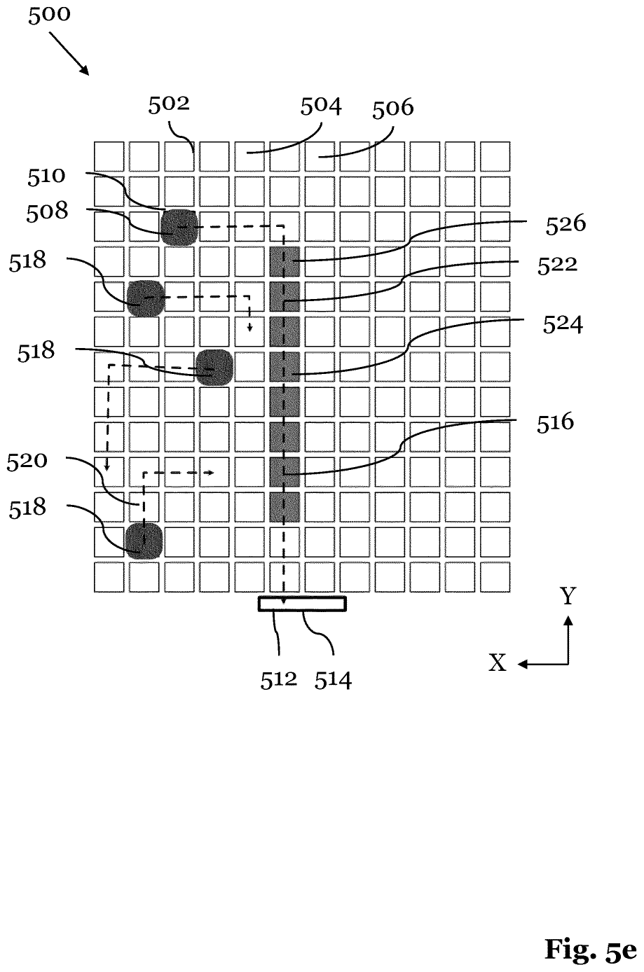

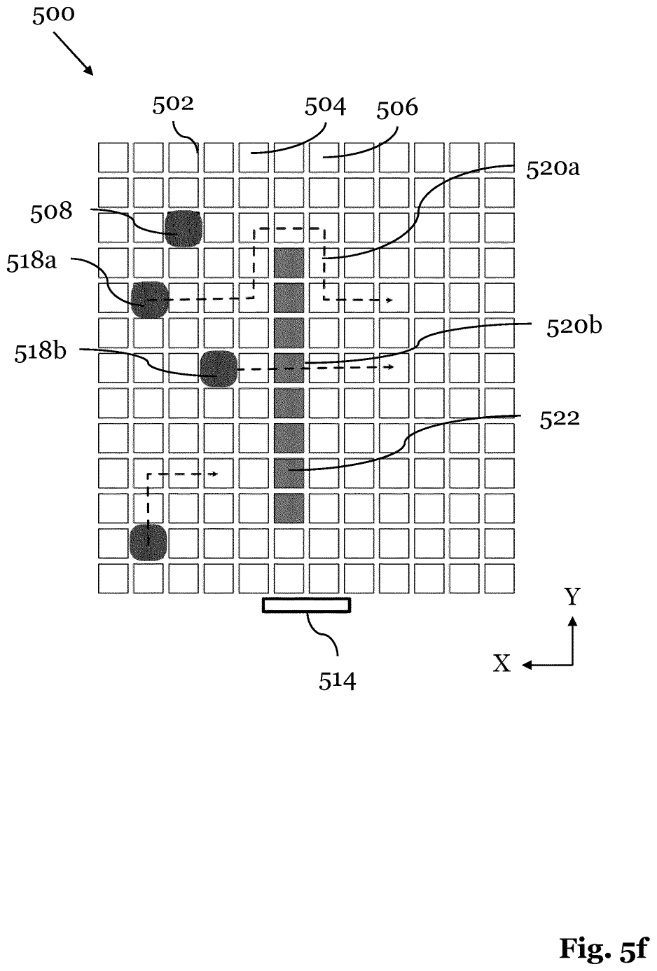

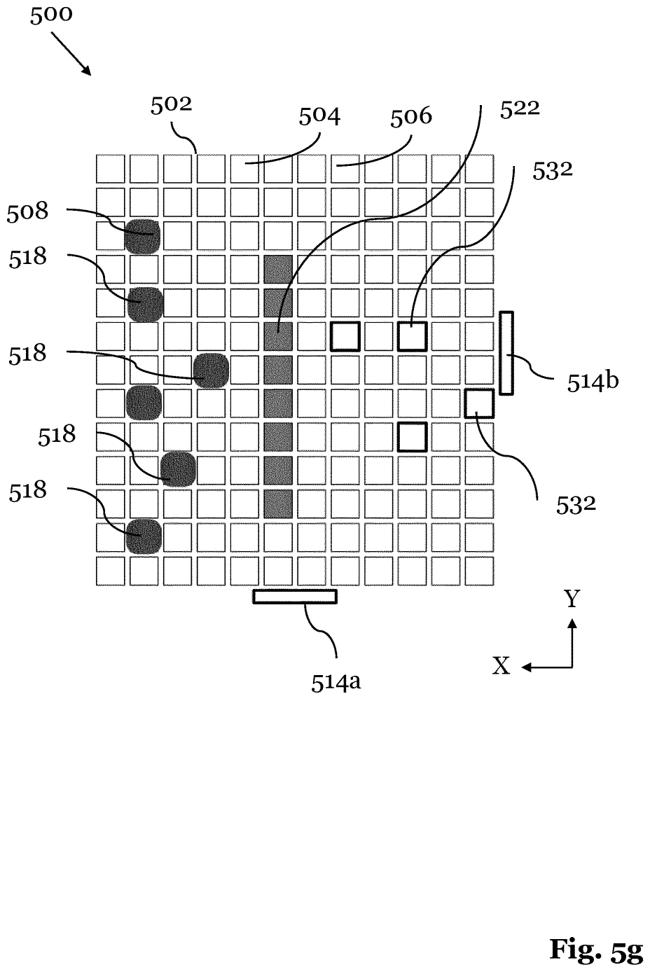

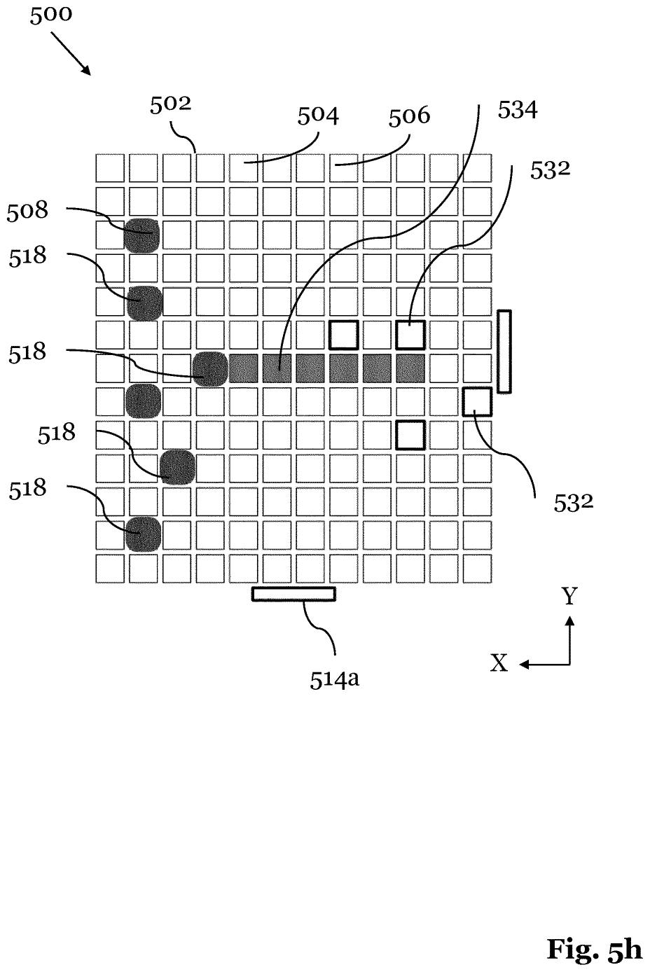

FIG. 5a shows a top-down view of an automated storage and retrieval system 500. The automated storage and retrieval system 500 includes a grid 502 of storage unit 504, each storage unit 504 at a grid location 506. The grid location 506 may be represented as an X coordinate and a Y coordinate as shown in FIG. 5a. Each storage unit 504 may extend out-of-plane, into the page in a Z-direction, in which there may be multiple bins or containers stacked on top of one another. For simplicity, one container handling vehicle 508 is shown in FIG. 5a, although it will be appreciated that any number of container handling vehicles 508 may be operating on the grid 502 at a time. The container handing vehicle 508 may be assigned a job which involves travelling from the first position 510 at which it is located, to a second position 512. In the example shown in FIG. 5a, the container handling vehicle 508 is assigned the first task of travelling to the second position 512 in order to retrieve a bin from the storage unit at the second location 512. It may be that retrieval of the bin is done for the purpose of digging to uncover a bin located lower down in the Z-direction, in which case the bin may be placed in another storage unit 504 at another grid location 506. Alternatively, it may be that retrieval of the bin from the storage unit 504 at the second location is done for the purpose of transporting the bin to a port 514 for an item to be picked.

Turning now to FIG. 5b, a first path 516 is shown for the container handling vehicle 508 is shown. The path 516 may be determined by any appropriate pathfinding algorithm, for example Dijkstra's algorithm or the A* algorithm. In the case of the grid 502, each grid location 506 may be considered to be a node for the purposes of the pathfinding algorithm, and each grid location 506 is connected to each adjacent grid location 506 by an edge. On the grid 502, the vehicles 508 of the depicted storage and retrieval system 500 are constrained to traverse the grid in either of the X-direction or the Y-direction at any one time. That is, the vehicles 508 of the present example do not traverse the grid 502 along the diagonal. Therefore, for a grid location 506 within the grid 502, the grid location 506 is connected to four other nodes via four edges. For a grid location 506 on an outer edge of the grid 502, the grid location 506 is connected to three other nodes via three edges. For a grid location 506 on a corner of the grid 502, the grid location is connected to two other nodes via two edges. Of course, whilst the grid 502 of the example is shown as a rectangular form, the grid 502 may take all kinds of shapes arranged in a grid pattern. For example, the grid 502 may include gaps (e.g. where a building pillar is in the way), multiple corners (e.g. where a grid is filling the space in a non-rectangular building), or channels (e.g. where a grid is located in two connected buildings).

To determine the path 516 shown in FIG. 5b, the pathfinding algorithm may first include determining for each of the connected edges, which of the candidate grid locations 506 adjacent to the first position 510 are the most promising. In the case of the A* algorithm a weight may be given to the edge in the Y-direction and another weight given to the edge in the X-direction. The weight may include, among other values, a distance from the second position 512. The smaller the distance from the second position 512, the smaller the weight applied to the corresponding edge. Other values may contribute to the weight, for example whether travelling in a particular direction will require the drive system of the vehicle 508 to reorientate. In the case shown in FIG. 5b, the drive system of the vehicle 508 is already orientated in the Y-direction, therefore the weight in the X-direction is greater than the weight in the Y-direction. The preferred edge is therefore the edge which leads in the Y-direction. In a next step, the pathfinding algorithm will repeat by assessing the weight for all available edges for the next grid location 506 located along the Y-direction. The preferred edge for each successive grid location 506 is assessed until the weight is zero and/or the vehicle 508 has reached the second position 512. In this case, the path chosen is the path 516 shown in FIG. 5b. However, it will be appreciated that other factors may be included in the weighting which may result in different paths taken. Additionally, for each determination of a preferred edge, there may be multiple preferred options (e.g. because two or more routes have the same weight). The pathfinding algorithm may continue exploring one or multiple routes until either a first or an optimised path is found.

Turning to FIG. 5c, another job to be performed by the vehicle 508 is shown. This time, the vehicle 508 starts at a first position 510. The second position 512 corresponds to a port 514 where the vehicle is to deposit a bin so that items in the bin may be picked. A path 516 is determined between the first position 510 and the second position 512 which involves two straight paths uninterrupted by other vehicles. As depicted in FIG. 5d, this may not be the case. Other vehicles 518 on the grid 502 carrying out their own tasks and travelling on their own paths 520 may present blockage or congestion to the vehicle 508. As will be apparent from FIG. 5d, the greater the distance that the vehicle 508 needs to travel, the more likely the vehicle 508 will encounter other vehicles 518 on its path 516. One way to avoid congestion might involve taking into account the paths 520 when determining the path 516. However, conflicts may occur as each path being determined may influence all other paths, and additionally not all paths may be known at the point in time at which the path 516 is being determined (i.e. additional paths 520 may be added after path 516 has already been determined). In accordance with an aspect of this disclosure, a virtual highway 522 may be defined.

FIG. 5e shows an instance where a virtual highway 522 is used for the calculation of the path 516. The virtual highway 522 is defined as a first subset 524 of the plurality of grid locations 506. In the example shown in FIG. 5e, the first subset 524 includes eight individual grid locations 506 extending in a line in the Y-direction. The first subset 524 may be pre-defined, for example by a user who has decided that the location of the first subset 524 is desired. Alternatively, the first subset 524 may be defined based on one or both of historical usage of the grid and future jobs that are expected to be needed. The first subset 524 may be permanent, semi-permanent, or temporary. That is the first subset 524 may be a feature of the grid 502 which does not change, or the first subset 524 may change in response to stimuli.

The pathfinding algorithm may be encouraged to utilise the virtual highway 522 by adjusting the cost or weight of using the virtual highway 522. In an example, the cost or weight of travelling from one grid location of the subset 524 to another grid location of the subset 524 may be lower than for travelling from one grid location not part of the subset to another grid location that is not part of the subset. The cost or weight of travelling from one grid location of the subset 524 to another grid location of the subset 524 may be a small positive value, zero, or even a negative value so that when determining the path 516, the pathfinding algorithm finds a lower cost for using the virtual highway 522.

It will be appreciated that a virtual highway 522 is beneficially oriented in a single direction. That is, vehicles 508, 518 will only travel in a one direction along the virtual highway 522. Should two directional travel be desired or required, an additional virtual highway 522 oriented in the opposite direction may be defined. In order to prevent the pathfinding algorithm from determining a path directed the wrong way along a virtual highway 522 either a high cost or weight may be applied to paths which are oriented in the wrong direction along the virtual highway 522, or a hard condition may be applied to prevent the virtual highway 522 from being used in the wrong direction.

To further encourage use by the pathfinding algorithm of the virtual highway 522, an entry point 526 to the virtual highway 522 may be defined. The entry point 526 may be defined as a waypoint along the path 516 that the vehicle 508 needs to pass through. Alternatively, use of the entry point 526 may be further encouraged by providing a lower cost or weight for the vehicle 508 to travel closer to the entry point 526 than to travel further away from the entry point 526. The effect of the lower cost or weight for vehicles 508 travelling toward the entry point 526 may be related to the proximity of the vehicle 508 to the entry point 526. That is, vehicles 508 which are closer to the entry point 526 may have a lower cost or weight for travelling towards the entry point 526, whereas vehicles which are further from the entry point 526 may not have a lower cost or weight for travelling towards the entry point 526. In effect, the entry point may have an area or a radius of effect on vehicle paths 516.

It will be appreciated that the path 516 shown in FIG. 5e advantageously avoids the paths 520 of the other vehicles 518 operating outside of the virtual highway 522 and provides a channel through which vehicles 508 may pass with a greater likelihood that other vehicle traffic is travelling in the same direction. The method may further include steps which prevent or discourage the use of the virtual highway 522 by vehicles which are not using the virtual highway 522 for the intended purpose (e.g. crossing the highway). Turning to FIG. 5f, avoidance of the virtual highway 522 by the other vehicles 508 can be seen. For clarity, the path 516 in FIG. 5f has been hidden. The first other vehicle 518a is required to travel across the virtual highway 522 to reach a destination on the other side of the virtual highway 522. When the pathfinding algorithm is presented with a next step which enters the virtual highway 522 from the side, and not in the direction of the virtual highway 522, the cost or weighting of travelling into the virtual highway 522 at the side is relatively high. Since the cost or weighting of travelling into the virtual highway 522 at the side is high, a preferred path which extends around the top of the virtual highway 522 is found. In the instance shown for the vehicle 518a, since the destination is directly on the other side of the virtual highway 522, the cost or weighting for a path 520a which travels around the virtual highway 522 is lower than the cost or weighting for a path which would intersect with the virtual highway 522. In another example, a second other vehicle 518b is located further along the virtual highway 522 than the vehicle 518a. The vehicle 518b is also required to find a path to a destination located on the opposite side of the highway 522. In the case of vehicle 518b, a path 520b entering and traversing the virtual highway 522 has a relatively high cost or weighting than a path of a similar length which does not traverse the virtual highway 522. However, in the case of vehicle 518b, the additional cost or weighting of the vehicle 518b entering and traversing the virtual highway 522 is not great enough to result in a total cost for the path 520b to be greater than an alternative path circumnavigating the virtual highway 522. In the case of vehicle 518b shown in FIG. 5f, the relative additional cost of entering and traversing the virtual highway 522 is at a level which discourages “misuse” of the virtual highway, but which does not prohibit traversal of the highway 522 where it may be advantageous to do so. Alternatively, the relative additional cost of entering and traversing the virtual highway 522 may be configured at a level which is prohibitive to any path being defined which would traverse the virtual highway 522.

Turning to FIG. 5g, a further example is shown in which it may be advantageous to remove a virtual highway 522. The grid 502 in FIG. 5g differs slightly from that shown in FIG. 5f in that the grid 502 in FIG. 5g has a first port 514a along a first side of the grid 502 as well as a second port 514b along a second side of the grid 502. In the instant shown in FIG. 5g, a large number of other vehicles 518 have destinations 532 or are required to reach the port 514b located on the opposite side of the virtual highway 522. In contrast, only one vehicle 508 is benefitting from the virtual highway 522 in travelling to port 514a. At this instant, it can be seen that the negative effect on the cost or weight on the paths of the other vehicles 518 outweighs the benefit to the path of the first vehicle 508. Advantageously, in response to such a situation where the total additional cost of paths negatively affected by the presence of the virtual highway 522 is greater than the total additional benefit of paths positively affected by the presence of the virtual highway 522, the virtual highway 522 may be removed. That is, the virtual highway 522 may no longer be defined in the pathfinding method, the cost or weighting attributed to the paths by the presence of the virtual highway 522 may be disregarded, the cost or the weighting attributed to paths by the presence of the virtual highway may be set to zero, or the virtual highway 522 may be deleted entirely.

It may be determined that a second virtual highway 534 may have a total additional benefit to paths which is greater than the benefit of no, or the first virtual highway 522. In which case, a second virtual highway 534 may be defined. The second virtual highway 534 may be a redefinition of the first virtual highway 522, or it may be a new or different virtual highway 534. The second virtual highway 534 may be located and/or oriented differently to the first virtual highway 534. In the examples shown, the first virtual highway 522 is oriented in the Y-direction and the second virtual highway 534 is oriented in the X-direction. In the case shown in FIG. 5h, since there are a greater number of vehicles 518 having paths which are required to traverse the grid in the X-direction than the number of vehicles 508 having paths which are required to traverse the grid in the Y-direction, it is beneficial to define the second virtual highway 534 and not define the first virtual highway 522.

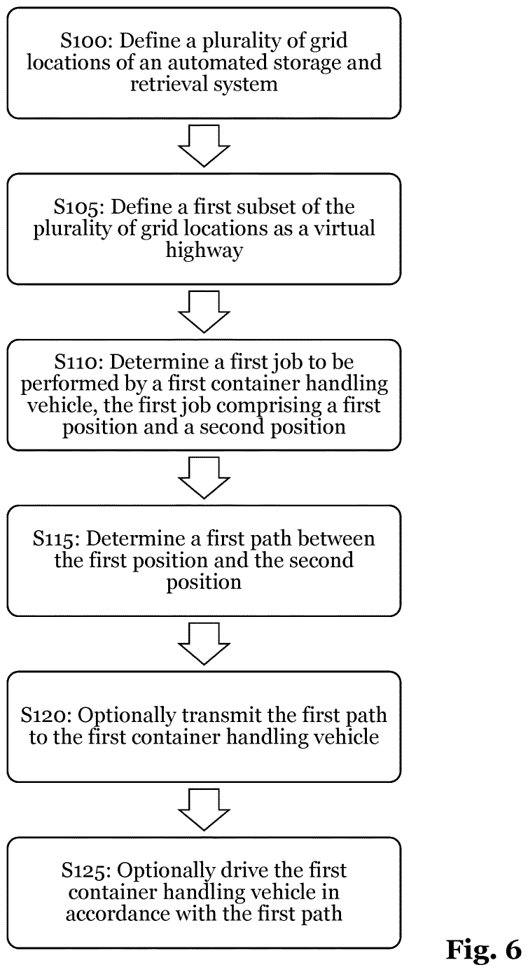

Turning to FIG. 6, there is described a method of controlling a plurality of container handling vehicles operating in an automated storage and retrieval system, comprising the steps of defining S100 a plurality of grid locations of the automated storage and retrieval system; defining S105 a first subset of the plurality of grid locations as a virtual highway; S110 determining a first job to be performed by a first container handling vehicle, the first job comprising a first position and a second position; S115 determining a first path between the first position and the second position. The method may optionally further comprise S120 transmitting the first path to the first container handling vehicle, and further optionally S125 driving the first container handling vehicle in accordance with the first path.

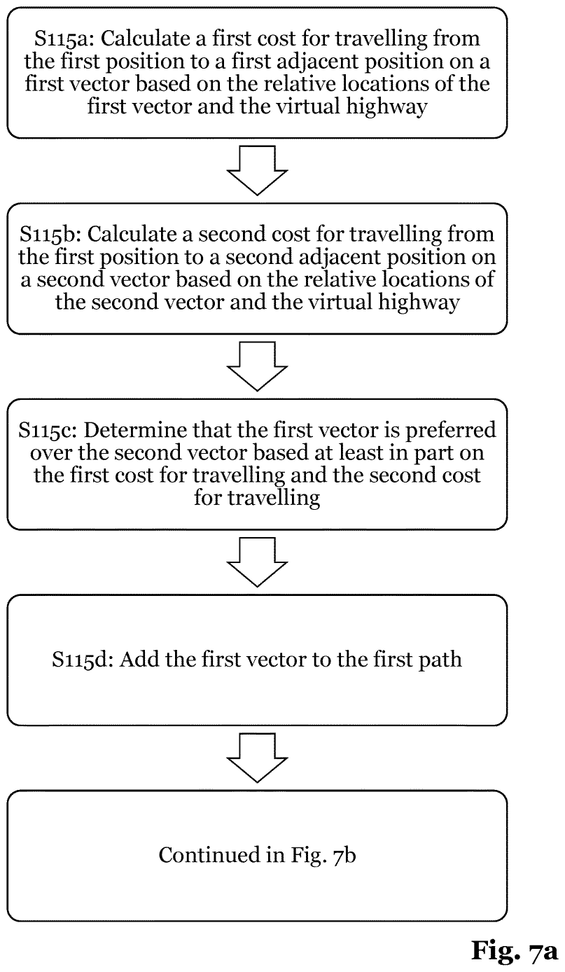

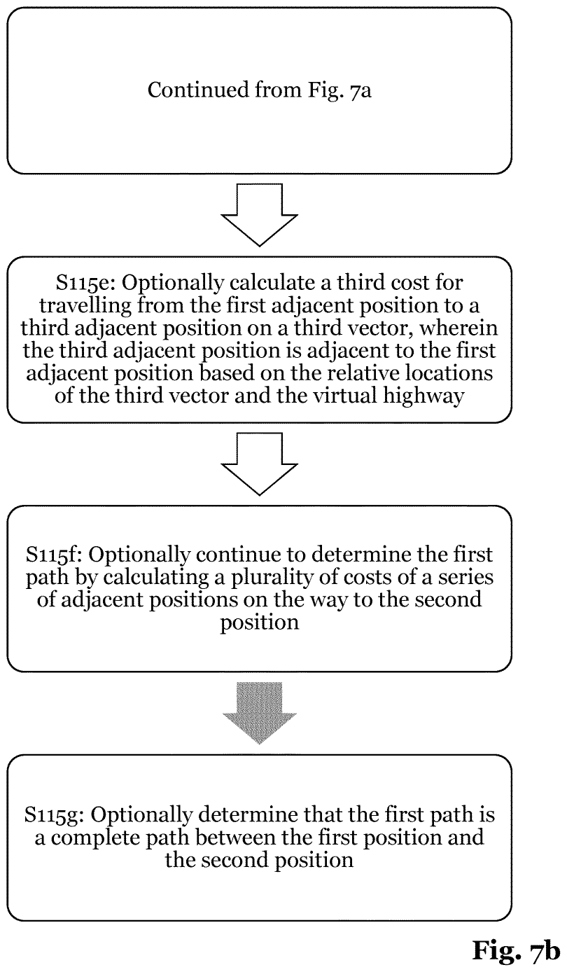

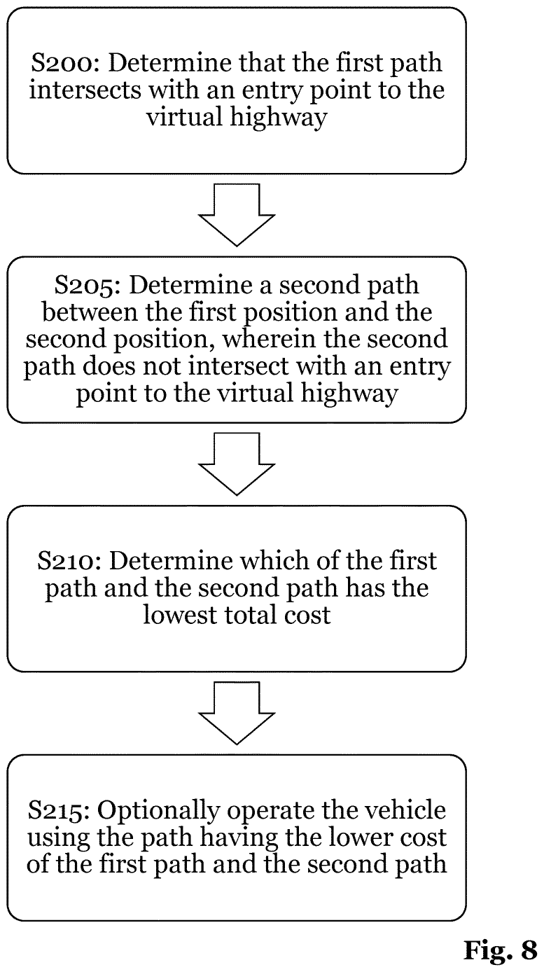

Turning to FIG. 7a, determining the first path comprises: S115a calculating a first cost for travelling from the first position to a first adjacent position on a first vector, based on the relative locations of the first vector and the virtual highway, S115b calculating a second cost for travelling from the first position to a second adjacent position on a second vector, based on the relative locations of the second vector and the virtual highway, and S115c determining that the first vector is preferred over the second vector based at least in part on the first cost for travelling and the second cost for travelling, and S115d adding the first vector to the first path.

In an example of using an A* search algorithm to find a path, in each iteration of determining costs of extending the path from the first position to any of the adjacent positions on the grid the following function may be minimised:

$$f ( n ) = g ( n ) + h ( n )$$

wherein f is the function to be minimised, g(n) is the cost of the path from the first position to the adjacent position n, and h(n) is an estimate of the cost of the cheapest path from the adjacent position n to the second position. h(n) may be any appropriate heuristic function. For example, the heuristic function may be a calculation of the straight line or Euclidean distance from the adjacent position n to the second position. In another example, the heuristic function may be the Taxicab or Manhattan distance between the adjacent position n and the second position. That is the sum of the distances in each of the X-direction and the Y-direction. In further examples, the heuristic function may be a calculation of the Chebyshev distance or the Minkowski distance between the adjacent position n and the second position.

The vector may be considered to be a representation of the extension of the path from the first position to the adjacent position. That is, the vector encodes the move from each position to the adjacent positions. This may be important for instance where the virtual highway must be used in a certain direction. The vector may encode the movement from the first position to the adjacent position by means of two sets of X-Y coordinates (e.g. grid [1,1] to grid [1,2]) or by means of an X-Y coordinate and a unit direction (e.g. grid [2,2] and unit direction [1,0], or grid [2,2] and unit direction [0, −1]). The vector may alternatively describe the movement from the first position to an adjacent by any other suitable means, that is a means of describing the location and the direction of travel of the vehicle.

In the present examples, the cost function g(n) is influenced in some way by the presence of the virtual highway. However, other influences to the cost function may also be present. For example, there may be an additional cost for a move from the first position to an adjacent position which requires the vehicle to change speed or change direction. A change of speed or a change of direction may take additional time or energy and may therefore be seen as a cost to reaching the second position. In other examples there may be an additional cost for any move from the first position to an adjacent position which occurs at a speed lower than a top speed.

In the present examples, the cost function g(n) may be influenced by the presence of the virtual highway by one or more of the proximity to the highway, the proximity to an entry point of the highway, being located on the highway, travelling towards the highway, travelling away from the highway, travelling across the highway, travelling with the direction of the highway, and travelling against the direction of the highway.

It will be appreciated that the path may be built up over a plurality of iterations of the minimisation of f(n) until at least a full path has been determined. For each iteration, the new adjacent positions are considered by the function f(n) for cost and heuristic of the benefit of the move. Once the total path from the first position to the second position has been determined, additional paths may be calculated and then compared to the first total path in order to optimise the total path.

Turning to FIG. 7b, determining the first path may optionally comprise calculating a third cost for travelling from the first adjacent position to a third adjacent position on a third vector, wherein the third adjacent position is adjacent to the first adjacent position, based on the relative locations of the third vector and the virtual highway. For example, the third adjacent position may be an additional step beyond the first adjacent position. Further adjacent positions may be determined in further iterations of determining the first path until a complete path is determined.

It will be appreciated that the plurality of grid locations may extend in a first direction, and in a second direction, the second direction being perpendicular to the first direction. For example, the grid may be distributed across an X-Y plane. In this way, the grid locations may be defined by Cartesian coordinates. In the present example, the vehicles are capable of travel in the X-direction, travel in the Y-direction, and changing direction between the X-direction and the Y-direction. However, the methods and systems presented herein may be extended to grids having other dimensions as well. For example, where a vehicle may travel in any of the X-direction, the Y-direction, and a third direction at an angle intersecting the X-direction and the Y-direction, paths may be determined based on travel in all three directions. The methods may readily be extended to this situation by considering the two adjacent positions in the X-direction, the two adjacent positions in the Y-direction, and the two adjacent positions in the third direction intersecting the X and Y directions. The method may further be extended to a fourth direction perpendicular to the third direction by additionally considering in each iteration the two adjacent positions in the fourth direction. Where the vehicles are capable of travelling diagonally, it may be more appropriate to calculate the heuristic h(n) as the Chebyshev distance or the Minkowski distance.

The virtual highway may be defined by a first subset of the plurality of grid locations. The first subset of the plurality of grid locations may be arranged in one of the first direction or the second direction. That is, the virtual highway may be a straight highway pointing along the first direction or the second direction. The virtual highway may have an orientation and a direction. That is, the virtual highway may be one-way. Where the virtual highway is one-way, the cost function in each iteration of f(n) may take into account whether the vector indicates travel in the correct direction, or travel in the wrong direction. Travel in the wrong direction may be penalised with a high cost, whereas travel in the correct direction may be rewarded by a relatively low cost.

Alternatively, the first subset of the plurality of grid locations may be arranged to include one or a plurality of corners. That is, the virtual highway may be arranged so that vehicles travelling along the highway do not follow a straight path. The plurality of grid locations may be arranged in an L-shape extending in the first direction and in the second direction such that the virtual highway includes one turn around one corner. The plurality of grid location may be arrange in more complex shapes which allow multiple turns around multiple corners. Including corners in the virtual highway may allow certain locations to be avoided whilst still benefitting from the virtual highway for pathfinding. For example, corners may be included in a virtual highway in order to avoid a particular grid location where vehicles need to retrieve a container or dig for a lower container. In other examples, obstacles such as damaged track, a stationary vehicles, or missing track (e.g. where there is a building pillar or other structure) may benefit from virtual highways including one or more corners.

In determining the cost or weight g(n), values may be determined which are negative, zero, lower than a default cost of movement, or lower than an average cost of movement on the plurality of grid locations. A negative cost would drop the value of g(n) such that f(n) may be lower. Similarly, zero cost may drop the value of g(n) such that f(n) may be lower. In another example, the cost may influence the minimisation of f(n) by being lower than a default cost of movement. For example, movement around the grid in general may take a default value (e.g. 1, 50, 100, or any appropriate number). Where the cost is to be influenced by the presence of a virtual highway, the cost may be lower than that default value by some amount (e.g. 0, 25, 90, or any appropriate number). By being lower than a default value, the cost function may encourage use of the virtual highway because the cost creates a minimum. It will be understood that cost may be a relative value because the function f(n) is minimised. Therefore, a cost which is lower than an average cost of movement around the grid taking into account multiple costs may encourage use of the virtual highway. That is, so long as the reduced cost of movement around the grid is lower for using the virtual highway than it otherwise would be without the virtual highway being present, the pathfinding algorithm will encourage use of the virtual highway.

Conversely, misuse of the virtual highway may be discouraged by a greater cost value. The cost may be positive, zero, greater than a default cost of movement, or greater than an average cost of movement on the plurality of grid locations. Since the relative cost will influence the minimisation of f(n), any greater than default cost, or greater than average cost will discourage use of paths which misuse the highway. Misuse of the virtual highway may include one or more of crossing the highway, entering the highway at a point other than an entry point and travelling the wrong way along the highway.

It may be beneficial to temporarily or permanently remove the virtual highway. For example, after the virtual highway has been used for one or more paths, the needs of the vehicles on the grid may be different and the presence of the highway may negatively affect the pattern of paths now required. For example, the virtual highway may have been beneficial for a first set of paths but now there are a large number of paths requiring to cross the virtual highway. In response to determining that the virtual highway should be removed (e.g. by determining that a threshold negative effect on vehicle paths has been exceeded) the virtual highway may be removed or turned off. The virtual highway may be removed from any definitions of virtual highways, or it may be disregarded in the calculation of the cost function for pathfinding. Once the virtual highway has been removed or turned off for the determination of one or more paths, the virtual highway may be reinstated or turned on again. Alternatively, the virtual highway may remain permanently removed or turned off indefinitely. The virtual highway may be removed or turned off for the benefit of retrieving containers which are located in the first subset of the plurality of grid locations. That is, the virtual highway may be removed or turned off because it is covering a grid location which a vehicle needs to carry out a retrieval task. Alternatively, to removing or turning off the virtual highway, the virtual highway may be redefined so that it includes a different subset of the plurality of grid locations. The different subset of the plurality of grid locations may have some grid locations in common with the first subset of the plurality of grid locations, or it may have no grid locations in common. For example, the redefined or second virtual highway may be located in an entirely different place, or it may be a rerouted version of the first virtual highway. For example, the entire highway may be shifted over by one grid location to avoid a particular grid location, or a corner may be defined in the virtual highway to circumnavigate a particular grid location.

The definition of a virtual highway in general may be responsive to determining that a plurality of jobs span the plurality of grid locations and that there is no other virtual highway currently defined across the determined span. For example, a threshold number of jobs extending from one end of the grid to another end of the grid may indicate that the presence of a virtual highway may be beneficial. Should there be no appropriate virtual highway already defined, a new virtual highway may be defined. Additionally or alternatively to a threshold number of jobs, the length of the span of the jobs across the grid may trigger the definition of a virtual highway. For example, where one or more jobs are determined to span greater than 30% of the total span of the grid a virtual highway may be defined. In another example, where the determined span is greater than 50% of the total span of the grid a virtual highway may be defined. In yet another example, where the determined span is greater than 75% of the total span of the grid a virtual highway may be defined. The greater the distance across a span of the grid that a path needs to be determined, the more likely it is that other paths will intersect with the path. Therefore, a threshold span of one or more jobs may be a good indicator that the presence of a virtual highway may be beneficial to reducing congestion or conflict of paths, and a virtual highway may be defined.

The methods may be implemented by a controller. The controller may include one or a plurality of processors, and the processors may be collocated (e.g. in a single computer) or may be distributed (e.g. across a network, in the cloud, or across the vehicles). Where vehicles have their own controllers for determining paths, each controller may communicate across a network to a main controller or with each other so as to determine the virtual highway, or to be sent a virtual highway from the main controller or from other controllers. Alternatively, each vehicle may simply operate under command from another controller and not include a controller for the determination of paths at all.

Instructions for executing the methods may be stored on a computer-readable medium. The computer-readable medium may be non-transitory.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1.-24. (canceled)

25. A method of controlling a plurality of container handling vehicles operating in an automated storage and retrieval system, comprising:
defining a plurality of grid locations of the automated storage and retrieval system;
defining a first subset of the plurality of grid locations as a virtual highway;
determining a first job to be performed by a first container handling vehicle, the first job comprising a first position and a second position;
determining a first path between the first position and the second position, wherein determining the first path comprises:
calculating a first cost for travelling from the first position to a first adjacent position on a first vector, based on the relative locations of the first vector and the virtual highway, calculating a second cost for travelling from the first position to a second adjacent position on a second vector, based on relative locations of the second vector and the virtual highway, determining that the first vector is preferred over the second vector based at least in part on the first cost for travelling and the second cost for travelling, and adding the first vector to the first path.

26. The method of claim 25, wherein determining the first path further comprises calculating a third cost for travelling from the first adjacent position to a third adjacent position on a third vector, wherein the third adjacent position is adjacent to the first adjacent position, based on the relative locations of the third vector and the virtual highway.

27. The method of claim 25, wherein determining the first path further comprises determining that the first path is a complete path between the first position and the second position.

28. The method of claim 25, further comprising:
transmitting the first path to the first container handling vehicle; and
optionally, driving the first container handling vehicle in accordance with the first path.

29. The method of claim 25, wherein the plurality of grid locations extends in a first direction, and wherein the plurality of grid locations extends in a second direction, the second direction being perpendicular to the first direction.

30. The method of claim 29, wherein the first subset of the plurality of grid locations is arranged in one of the first direction or the second direction.

31. The method of claim 29, wherein the first subset of the plurality of grid locations is arranged to include one or a plurality of corners, and optionally wherein the first subset of the plurality of grid locations is arranged in an L-shape extending in the first direction and in the second direction.

32. The method of claim 25, wherein the first adjacent position is closer to an entry point of the virtual highway than the first position is to the entry point of the virtual highway, and optionally wherein the first cost is determined to be negative, zero, lower than a default cost of movement, or lower than an average cost of movement on the plurality of grid locations.

33. The method of claim 25, wherein the second adjacent position is further from an entry point of the virtual highway than the second position is from the entry point of the virtual highway, and optionally wherein the second cost is determined to be positive, zero, greater than a default cost of movement, or greater than an average cost of movement on the plurality of grid locations.

34. The method of claim 25, wherein the first vector is determined to follow a direction of the virtual highway, and optionally wherein the first cost is determined to be negative, zero, lower than a default cost of movement, or lower than an average cost of movement on the plurality of grid locations.

35. The method of claim 25, wherein the second vector is determined to not follow a direction of the virtual highway, and optionally wherein the second cost is determined to be positive, zero, greater than a default cost of movement, or greater than an average cost of movement on the plurality of grid locations.

36. The method of claim 25, wherein the second vector is determined to enter the virtual highway at a location other than an entry point of the virtual highway, and optionally wherein the second costs are determined to be positive, zero, greater than a default cost of movement, or greater than an average cost of movement on the plurality of grid locations.

37. The method of claim 25, wherein the second position is an entry point of the virtual highway, or wherein the second position is a port location of the plurality of grid locations, or wherein the second position is a target grid location.

38. The method of claim 25, further comprising:
determining that the first path intersects with an entry point to the virtual highway,
determining a second path between the first position and the second position, wherein the second path does not intersect with an entry point to the virtual highway, and
determining which of the first path and the second path has a lowest total cost.

39. The method of claim 25, further comprising removing the virtual highway for the determination of one or more paths other than the first path, optionally wherein removal of the virtual highway is responsive to determining that one or more containers to be retrieved are located in the first subset of the plurality of grid locations.

40. The method of claim 25, further comprising defining a second subset of the plurality of grid locations as a second virtual highway for the determination of one or more paths other than the first path, optionally wherein defining the second virtual highway is responsive to determining that a plurality of jobs span the plurality of grid locations and that there is no other virtual highway currently defined across the determined span, and optionally wherein the determined span is greater than 30% of a total span of the grid, further optionally wherein the determined span is greater than 50% of the total span of the grid, and further optionally wherein the determined span is greater than 75% of the total span of the grid.

41. A controller configured to perform a method of controlling a plurality of container handling vehicles operating in an automated storage and retrieval system, the method comprising:
defining a plurality of grid locations of the automated storage and retrieval system;
defining a first subset of the plurality of grid locations as a virtual highway;
determining a first job to be performed by a first container handling vehicle, the first job comprising a first position and a second position;
determining a first path between the first position and the second position, wherein determining the first path comprises:
calculating a first cost for travelling from the first position to a first adjacent position on a first vector, based on relative locations of the first vector and the virtual highway, calculating a second cost for travelling from the first position to a second adjacent position on a second vector, based on the relative locations of the second vector and the virtual highway, determining that the first vector is preferred over the second vector based at least in part on the first cost for travelling and the second cost for travelling, and adding the first vector to the first path.

42. A computer-readable medium comprising instructions which, when executed by a processor of an automated storage and retrieval system or a container handling vehicle, cause the automated storage and retrieval system or the container handling vehicle to execute controlling a plurality of container handling vehicles operating in an automated storage and retrieval system by:
defining a plurality of grid locations of the automated storage and retrieval system;
defining a first subset of the plurality of grid locations as a virtual highway;
determining a first job to be performed by a first container handling vehicle, the first job comprising a first position and a second position;
determining a first path between the first position and the second position, wherein determining the first path comprises:
calculating a first cost for travelling from the first position to a first adjacent position on a first vector, based on the relative locations of the first vector and the virtual highway, calculating a second cost for travelling from the first position to a second adjacent position on a second vector, based on relative locations of the second vector and the virtual highway, determining that the first vector is preferred over the second vector based at least in part on the first cost for travelling and the second cost for travelling, and adding the first vector to the first path.
